(19) United States
(12) Patent Application Publication
(10) Pub. No.: US 2007/0291782 A1
(43) Pub. Date: Dec. 20, 2007

(54) ACKNOWLEDGEMENT FILTERING

(76) Inventors: Claude Basso, Raleigh, NC (US); Donald W. Schmidt, Stone Ridge, NY (US); Venkat Venkatsubra, Austin, TX (US)

Correspondence Address: HOFFMAN WARNICK & DALESSANDRO LLC, 75 STATE ST, 14TH FLOOR, ALBANY, NY, 12207, US

(21) Appl. No.: 11/424,043

(22) Filed: Jun. 14, 2006

(51) Int. Cl. H04L 12/56; H04L 12/54; H04L 1/18

(52) U.S. Cl. 370/428; 370/412; 714/748

(57) ABSTRACT

A solution for managing a communications connection, in which one or more acknowledgements are filtered is provided. In particular, data can be obtained for forwarding to a remote device, and at least some of the data can be communicated for processing on the remote device. Subsequently, an acknowledgement is received for the at least some of the data, and a determination is made as to whether to forward the acknowledgement based on an optimization configuration. The invention can include several checks to ensure that any acknowledgement that should be forwarded for further processing is properly forwarded. In one embodiment, the invention is implemented on a network adapter, and enables numerous acknowledgements that are received by the network adapter for a large send data packet to be filtered and not provided to a protocol stack.

### FIELD OF THE INVENTION

The invention relates generally to communications management, and more particularly, to a solution for filtering acknowledgements received for a communications connection.

### BACKGROUND OF THE INVENTION

As the speed of networking interfaces increases, the amount of processing required to implement communications over the networking interfaces is becoming a performance bottleneck. For example, a transmission control protocol (TCP) stack requires a significant amount of processing to implement TCP communications. To address the processing requirements of the TCP stack, two approaches have been proposed.

In a first approach, TCP processing is completely offloaded from the protocol stack to a network interface card (NIC). In this approach, the NIC can use remote direct memory access (RDMA) to transmit data without requiring a processing unit on the computing device. This approach requires implementation of the TCP stack in hardware and/or firmware on the NIC, making it difficult to debug, maintain, enhance, etc. Further, both ends of a communications connection must support RDMA to successfully communicate.

In a second approach, the TCP stack continues to execute on the main processor while some of the processing tasks are offloaded to the NIC. For example, the NIC can perform a TCP checksum. Further, when transmitting data, the TCP stack can use TCP segmentation offload (TSO) or “TCP large send”. In this case, the TCP stack provides the NIC with packets of data for transmission (e.g., 64 kilobytes) that are larger than that which can be transmitted in a single packet. The NIC segments the data into a number of packets of the required size (e.g., 1500 bytes) for transmission. By managing larger packets of data, the protocol overhead for the TCP stack is reduced. To address the processing requirements upon receiving data, only a limited number of strategies have been proposed, such as a per TCP connection demultiplexing and queuing and TCP/Internet Protocol (IP) headers separation thereby enabling functions such as operating system bypass and zero copy operation.

In view of the foregoing, a need exists to overcome one or more of the deficiencies in the related art.

### BRIEF SUMMARY OF THE INVENTION

The invention provides a solution for managing a communications connection, in which one or more acknowledgements are filtered. In particular, data can be obtained for forwarding to a remote device, and at least some of the data can be communicated for processing on the remote device. Subsequently, an acknowledgement is received for the at least some of the data, and a determination is made as to whether to forward the acknowledgement based on an optimization configuration. The invention can include several checks to ensure that any acknowledgement that should be forwarded for further processing is properly forwarded. In one embodiment, the invention is implemented on a network adapter, and enables numerous acknowledgements that are received by the network adapter for a large send data packet to be filtered and not provided to a protocol stack.

A first aspect of the invention provides a method of managing a communications connection, the method comprising: obtaining data for forwarding to a remote device; communicating at least some of the data for processing on the remote device; receiving an acknowledgement for the at least some of the data; and determining whether to forward the acknowledgement based on an optimization configuration.

A second aspect of the invention provides a system for managing a communications connection, the system comprising: a system for obtaining data for forwarding to a remote device; a system for communicating at least some of the data for processing on the remote device; a system for receiving an acknowledgement for the at least some of the data; and a system for determining whether to forward the acknowledgement based on an optimization configuration.

A third aspect of the invention provides a computer program stored on a computer-readable medium, which when executed, enables a computer system to manage a communications connection, the computer program comprising program code for enabling the computer system to: obtain data for forwarding to a remote device; communicate at least some of the data for processing on the remote device; receive an acknowledgement for the at least some of the data; and determine whether to forward the acknowledgement based on an optimization configuration.

A fourth aspect of the invention provides a network adapter comprising: means for obtaining data for forwarding to a remote device; means for communicating at least some of the data for processing on the remote device; means for receiving an acknowledgement for the at least some of the data; and means for determining whether to forward the acknowledgement based on an optimization configuration.

A fifth aspect of the invention provides a method of generating a system for managing a communications connection, the method comprising: providing a computer system operable to: obtain data for forwarding to a remote device; communicate at least some of the data for processing on the remote device; receive an acknowledgement for the at least some of the data; and determine whether to forward the acknowledgement based on an optimization configuration.

A sixth aspect of the invention provides a business method for managing a communications connection, the business method comprising managing a computer system that performs the process described herein; and receiving payment based on the managing.

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 shows an illustrative environment for managing a communications connection according to an embodiment of the invention.

FIG. 2 shows an illustrative data flow diagram for communicating a large data packet according to an embodiment of the invention.

FIG. 3 shows an illustrative process for determining whether to forward an acknowledgement for processing by a protocol stack according to an embodiment of the invention.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, the invention provides a solution for managing a communications connection, in which one or more acknowledgements are filtered. In particular, data can be obtained for forwarding to a remote device, and at least some of the data can be communicated for processing on the remote device. Subsequently, an acknowledgement is received for the at least some of the data, and a determination is made as to whether to forward the acknowledgement based on an optimization configuration. The invention can include several checks to ensure that any acknowledgement that should be forwarded for further processing is properly forwarded. In one embodiment, the invention is implemented on a network adapter, and enables numerous acknowledgements that are received by the network adapter for a large send data packet to be filtered and not provided to a protocol stack. As used herein, unless otherwise noted, the term “set” means one or more (i.e., at least one) and the phrase “any solution” means any now known or later developed solution.

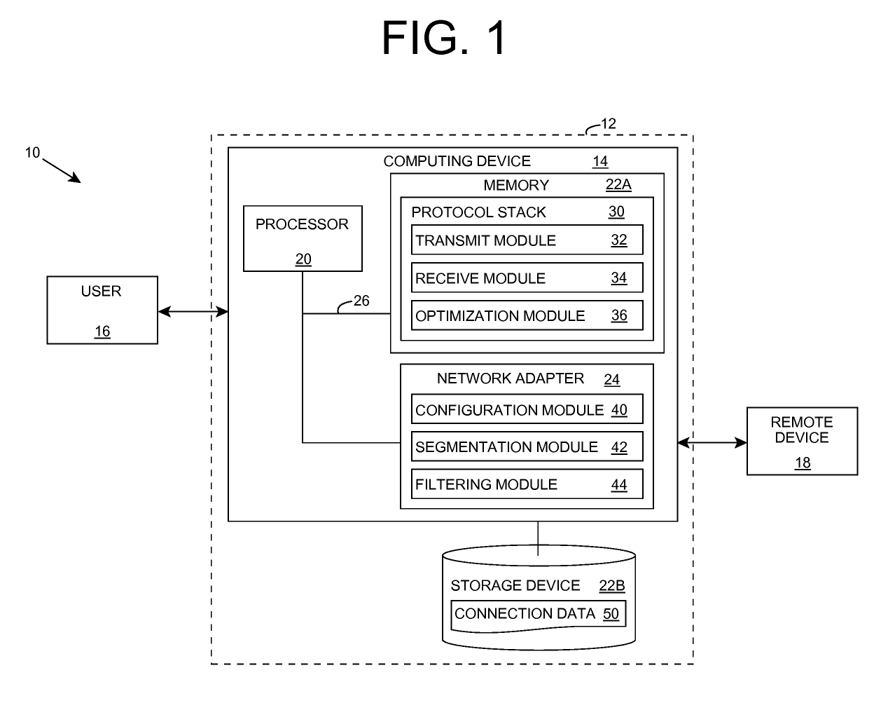

Turning to the drawings, FIG. 1 shows an illustrative environment 10 for managing a communications connection according to an embodiment of the invention. To this extent, environment 10 includes a computer system 12 that can perform the process described herein in order to manage a communications connection. In particular, computer system 12 is shown including a computing device 14 that comprises a protocol stack 30 and a network adapter 24, which make computing device 14 operable to manage a communications connection with a remote device 18 by performing the process described herein.

Computing device 14 is shown including a processor 20, a memory 22A, a network adapter 24, and a bus 26. Further, computing device 14 is shown in communication with a storage device 22B. As is known in the art, in general, processor 20 executes program code, such as protocol stack 30, which is stored in memory 22A and/or storage device 22B. While executing program code, processor 20 can read and/or write data, such as connection data 50, to/from memory 22A, storage device 22B, and/or network adapter 24. Bus 26 provides a communications link between each of the components in computing device 14. While not shown, it is understood that computing device 14 can include other types of I/O interface(s) and/or I/O device(s) that enable data transfer between a user 16 (e.g., an individual) and/or remote device 18 (e.g., another computing system) and computing device 14 using any type of communications link.

In any event, computing device 14 can comprise any general purpose computing article of manufacture capable of executing program code installed thereon. However, it is understood that computing device 14 is only representative of various possible equivalent computing devices that may perform the process described herein. To this extent, in other embodiments, the functionality provided by protocol stack 30 and network adapter 24 can be implemented by a computing article of manufacture that includes any combination of general and/or specific purpose hardware and/or program code. In each embodiment, the program code and hardware can be created using standard programming and engineering techniques, respectively.

Similarly, computer system 12 is only illustrative of various types of computer systems for implementing the invention. For example, in one embodiment, computer system 12 comprises two or more computing devices that communicate over any type of communications link, such as a network, a shared memory, or the like, to perform the process described herein. For example, some or all of the functions described as being implemented by network adapter 24 could be implemented in a device implemented apart from computing device 14. Further, while performing the process described herein, one or more computing devices in computer system 12 can communicate with one or more other computing devices external to computer system 12 using any type of communications link. In either case, the communications link can comprise any combination of various types of wired and/or wireless links; comprise any combination of one or more types of networks; and/or utilize any combination of various types of transmission techniques and protocols.

As discussed herein, protocol stack 30 and network adapter 24 enable computer system 12 to manage a communications connection. To this extent, protocol stack 30 is shown including a transmit module 32, a receive module 34, and an optimization module 36, while network adapter 24 is shown including a configuration module 40, a segmentation module 42, and a filtering module 44. Operation of each of these modules is discussed further herein. However, it is understood that some of the various modules shown in FIG. 1 can be implemented independently, combined, and/or stored in memory for one or more separate computing devices that are included in computer system 12. Further, it is understood that some of the modules and/or functionality may not be implemented, or additional modules and/or functionality may be included as part of computer system 12.

Regardless, the invention provides a solution for managing a communications connection, in which network adapter 24 can filter one or more acknowledgements received as part of the communications connection rather than forwarding all acknowledgements for processing by protocol stack 30. In general, transmit module 32 receives data from a sending application, breaks up the data into packets for transmission, adds data for communication protocol(s) to each packet, and provides each packet to network adapter 24. Network adapter 24 transmits the packet over a network for processing by a destination device, e.g., remote device 18. Similarly, upon receiving a packet, e.g., from remote device 18, network adapter 24 provides the packet for processing by protocol stack 30. Receive module 34 removes and processes the data for communication protocol(s), can combine data from multiple packets (if necessary), and forwards the data to a destination application for processing.

Protocol stack 30 and/or network adapter 24 can simultaneously manage communications connections for multiple application/remote device 18 combinations. To this extent, protocol stack 30 and/or network adapter 24 can manage connection data 50 for each communications connection. Connection data 50 can be stored using any solution (e.g., one or more files, records in a database, and/or the like), and can include an identifier for a corresponding application, a window size, addressing/routing information, historical information, and/or the like. Additionally, connection data 50 can include one or more queues for processing messages (packet) for the communications connection. For example, connection data 50 can include a transmit queue, which transmit module 32 adds a message to be sent and from which network adapter 24 removes and sends messages. Similarly, connection data 50 can include a receive queue, which network adapter 24 adds a message that was received and from which receive module 34 removes and processes messages.

Further, connection data 50 can comprise data on one or more optimization configurations. To this extent, optimization module 36 can manage optimization configuration data, which is stored in connection data 50. In particular, optimization module 36 can obtain one or more desired optimization settings, and store the desired optimization settings as optimization configuration data in connection data 50. Optimization module 36 can obtain the optimization settings using any solution. For example, optimization module 36 can generate a user interface for display to user 16, which enables user 16 to select a set of desired optimization settings. Similarly, optimization module 36 can define an application program interface (API) or the like that enables another application/system to select a set of desired optimization settings. Still further, optimization module 36 can monitor communications over a communications connection and dynamically adjust the corresponding optimization configuration based on the communications. In any event, configuration module 40 can read connection data 50 (e.g., optimization configuration data) and adjust the operation of network adapter 24 based on connection data 50.

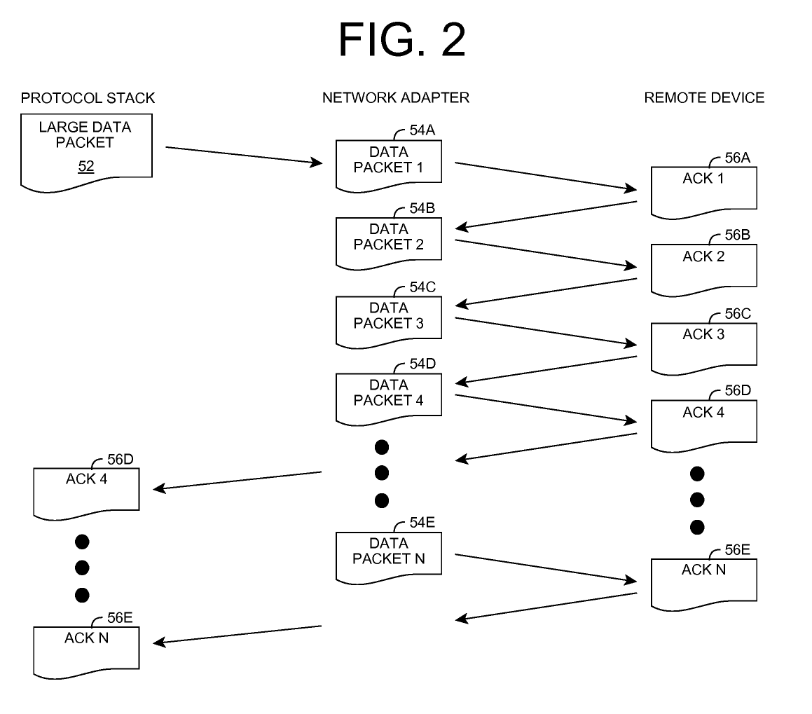

In an illustrative embodiment described herein, protocol stack 30 processes transmission control protocol (TCP) messages, e.g., protocol stack 30 comprises a TCP stack. In this case, connection data 50 can comprise a segmentation offload setting for designating whether protocol stack 30 provides large data packets for subsequent segmentation and transmission by network adapter 24. While the invention is primarily described with reference to segmentation offloading for illustration, it is understood that the invention can be implemented and used independent from the segmentation offloading functionality. In any event, FIG. 2 shows an illustrative data flow diagram for communicating a large data packet 52 according to an embodiment of the invention. Referring to FIGS. 1 and 2, when network adapter 24 is performing segmentation offload for protocol stack 30, protocol stack 30 will provide a large data packet 52 to network adapter 24. Segmentation module 42 will segment the large data packet 52 into numerous smaller data packets 54A-E, each of which conforms to a limitation as to the number of bytes allowed in a message. Network adapter 24 sends each data packet 54A-E for processing on the remote device 18.

Network adapter 24 can send data packets 54A-E using any solution. For example, as shown, network adapter 24 can send a data packet, such as data packet 54A and wait to receive an acknowledgement (ack) 56A in response to the data packet 54A before sending the next data packet 54B. However, it is understood that this data flow is only illustrative. To this extent, network adapter 24 can send data packets 54A-E sequentially, without waiting to receive any corresponding acknowledgements 56A-E. As they are received, network adapter 24 can process acknowledgements 56A-E and determine if any data packets 54A-E require retransmission. Additionally, for some communications protocols, such as a TCP communications connection, remote device 18 may not send an acknowledgement 56A-E in response to every data packet 54A-E. For example, remote device 18 may only send an acknowledgement 56A-E for every other data packet 54A-E that is received from network adapter 24. To this extent, network adapter 24 can implement the corresponding functionality for processing the fewer acknowledgements 56A-E.

Regardless, network adapter 24 may receive numerous acknowledgements 56A-E when communicating data packets 54A-E for a single large data packet 52. In this case, rather than forwarding each acknowledgement 56A-E, filtering module 44 can determine whether to forward the acknowledgement 56A-E to protocol stack 30 based on an optimization configuration included in connection data 50. In particular, connection data 50 can include a filtering setting for designating whether network adapter 24 should discard (e.g., not forward to protocol stack 30) any acknowledgements 56A-E received for the communications connection. Configuration module 40 can read the filtering setting in connection data 50 and adjust the processing of acknowledgements 56A-E accordingly.

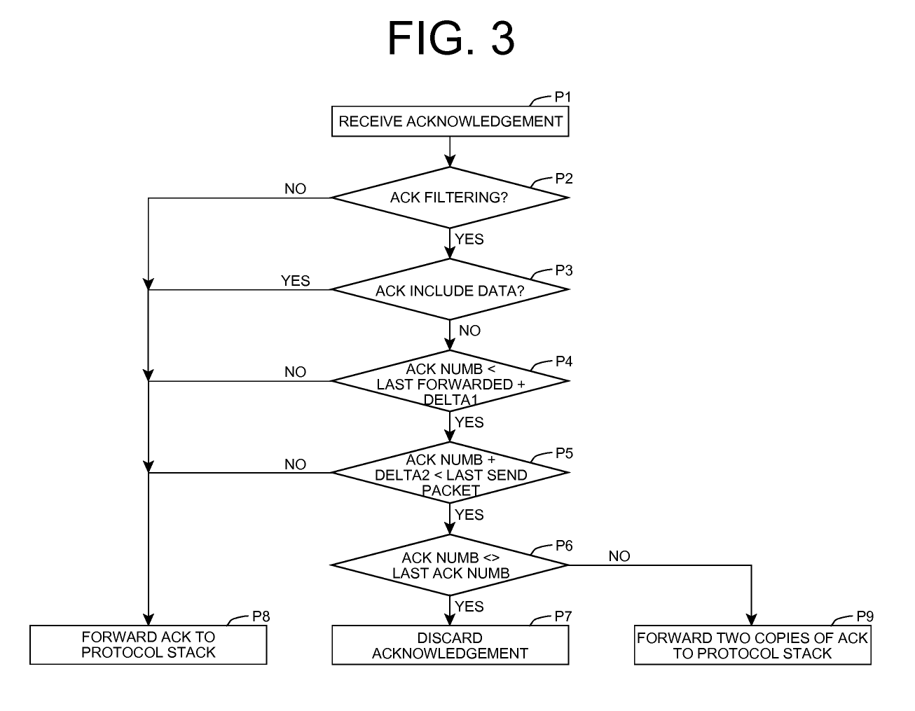

When filtering acknowledgements 56A-E for a communications connection, filtering module 44 can determine whether to forward the acknowledgement 56A-E to protocol stack 30 and process the acknowledgement 56A-E accordingly. For example, filtering module 44 can forward the acknowledgement 56A-E for processing by protocol stack 30, discard the acknowledgement 56A-E, and/or the like. FIG. 3 shows an illustrative process for determining whether to forward an acknowledgement 56A-E for processing by protocol stack 30 according to an embodiment of the invention, and which can be implemented by filtering module 44 (FIG. 1). Referring to FIGS. 1 and 3, in process P1, filtering module 44 receives an acknowledgement for a data packet previously sent by network adapter 24. In decision P2, filtering module 44 determines whether acknowledgements should be filtered. For example, filtering module 44 can determine whether acknowledgement filtering is active for the communications connection (e.g., by checking a filtering setting). If not, then in process P8, filtering module 44 can forward the acknowledgement for processing by protocol stack 30.

It is understood that filtering module 44 also can determine whether one or more other optimizations are currently active for the communications connection to determine whether acknowledgements should be filtered in decision P2. For example, filtering module 44 can determine whether segmentation offload is active (e.g., by checking a segmentation offload setting). When it is not, protocol stack 30 may expect to receive all acknowledgements. Additionally, a communications connection may implement selective acknowledgements, in which only certain data packets may require retransmission when a data packet is lost or received out of order. In this case, protocol stack 30 may need to process each acknowledgement in order to determine whether any data packet(s) requires retransmission. In either case, filtering module 44 can forward all acknowledgements for processing by protocol stack 30. However, it is understood that this is only illustrative, and filtering module 44 can filter acknowledgements even when segmentation offload is inactive or not implemented and/or selective acknowledgements are implemented.

If acknowledgements may be filtered, in decision P3, filtering module 44 can determine whether the acknowledgement includes any data required to be processed by protocol stack 30. For example, an acknowledgement can include response data communicated for processing by protocol stack 30 in response to a request generated by protocol stack 30. Similarly, an acknowledgement can include one or more flags (e.g., URG, PSH, RST, SYN, FIN). Further, an acknowledgement may include data on the communications connection, such as a window size that is smaller than a previous window size. However, in TCP communications, this situation is rare and not recommended, and therefore may be ignored by filtering module 44. In one or more of these situations, filtering module 44 can forward an acknowledgement that includes data for processing by protocol stack 30.

Assuming acknowledgement filtering is active and a pure acknowledgement (e.g., does not include other data) has been received, then filtering module 44 can determine whether to forward the acknowledgement for processing by protocol stack 30 based on its previous acknowledgement processing. For example, filtering module 44 can determine whether to forward an acknowledgement based on a previously forwarded acknowledgement. In particular, numerous data packets 54A-E (FIG. 2) may be required to send a single large data packet 52 (FIG. 2). Additionally, remote device 18 may not send an acknowledgement until after an application for which the data packet 54A-E is designated has read some or all of the data packet 54A-E (e.g., as in some Unix-based operating system TCP implementations). As a result, the transmission time for an entire large data packet 52 may exceed a time out period or the like for protocol stack 30.

To this extent, filtering module 44 can periodically forward an acknowledgement to protocol stack 30 to ensure that protocol stack 30 does not start resending packets due to a perceived lack of communications with remote device 18. In one embodiment, filtering module uses a threshold number of acknowledgements (e.g., a delta) to filter before forwarding another acknowledgement for processing by protocol stack 30. To this extent, optimization module 36 can store the threshold number in connection data 50, from which filtering module 44 can obtain the setting. Alternatively, filtering module 44 can use a fixed number. In either case, the threshold number can be set to filter between five and ten acknowledgements before forwarding another for processing by protocol stack 30.

In any event, as part of process P8, filtering module 44 can store an acknowledgement number of the last acknowledgement forwarded to protocol stack 30. In decision P4, filtering module 44 can compare the acknowledgement number of a current acknowledgement with the sum of the stored acknowledgement number of the last forwarded acknowledgement and the threshold number (DELTA1). If the acknowledgement number is greater than or equal to the sum, then filtering module 44 can forward the acknowledgement for processing by protocol stack 30. It is understood that this is only illustrative, and filtering module 44 can implement any solution for determining when a threshold number of acknowledgements has been exceeded (e.g., a counter).

Filtering module 44 also can determine whether to forward an acknowledgement based on a total number of data packets to be communicated for processing on remote device 18. In particular, filtering module 44 should forward the last acknowledgement 56E (FIG. 2) received for processing by protocol stack 30 to ensure that protocol stack 30 does not retransmit data based on a missing acknowledgement 56E. For example, when processing a TCP large send, segmentation module 42 can store a sequence number of the last data packet 54E (FIG. 2) that will be required for communicating large data packet 52 (FIG. 2).

In decision P5, filtering module 44 can determine whether the current acknowledgement is acknowledging a data packet having a sequence number less than the sequence number of the last data packet. If the acknowledgement is greater than or equal to the sequence number of the last data packet, then filtering module 44 can forward the acknowledgement for processing by protocol stack in process P8. However, for some protocols an acknowledgement may not be received for every data packet. For example, in TCP, an acknowledgement may only be received for every other data packet. In this case, filtering module 44 can use a second threshold number (DELTA2), which optimization module 36 can store in connection data 50. In particular, filtering module 44 can compare a sum of the second threshold number with the current acknowledgement sequence number to the sequence number for the last data packet, and forward an acknowledgement that is within the threshold number of the last data packet. In one embodiment, the second threshold number is within the range of one and two. However, it is understood that the second threshold can be selected based on the frequency of expected acknowledgements. For example, if an acknowledgement is expected for every data packet, then the second threshold could be set to zero.

Filtering module 44 also can determine whether to forward an acknowledgement based on a previous acknowledgement. For example, in TCP, remote device 17 can request retransmission and/or inform protocol stack 30 of a new window size by sending two consecutive duplicate acknowledgements. To this extent, filtering module 44 can compare a sequence number of the current acknowledgement with a sequence number for a previous acknowledgement. If the two sequence numbers differ, then filtering module 44 can discard the acknowledgement in process P7. Discarding the acknowledgement can comprise not forwarding the acknowledgement for processing by protocol stack. Further, discarding can include removing the acknowledgement from memory, storing the acknowledgement for a designated period of time/amount of acknowledgements, forwarding the acknowledgement to another system, and/or the like. Otherwise, in process P9, filtering module 44 can forward two copies of the acknowledgement for processing by protocol stack 30. Regardless, when filtering module 44 compares the sequence number of the previous acknowledgement to the sequence number of the current acknowledgement, then in each of processes P7-9, filtering module 44 can store the sequence number of the current acknowledgement for processing a subsequent acknowledgement.

In process P9, protocol stack 30 must receive two copies of the acknowledgement to ensure that it is processed as a duplicate acknowledgement. However, filtering module 44 may have already forwarded the previous acknowledgement in process P8. To this extent, in process P9 filtering module 44 can forward a first copy of the acknowledgement for processing by protocol stack 30, and then compare the sequence number for the previously forwarded acknowledgement to determine whether to send a second copy of the acknowledgement. In particular, if the sequence number of the previously forwarded acknowledgement equals the sequence number of the current acknowledgement, the second copy is not required. Otherwise, filtering module 44 can forward the second copy for processing by protocol stack 30.

As described herein, protocol stack 30 can dynamically manage the optimization configuration for the communications connection. To this extent, protocol stack 30 can select to enable and/or disable acknowledgement filtering for a communications connection. For example, protocol stack 30 can disable acknowledgement filtering for a new communications connection (e.g., during a slow start phase of a TCP connection). Additionally, protocol stack 30 can disable acknowledgement filtering for a communications connection that is congested (resulting in longer round trip delays), has unstable round trip delays, requires a lot of retransmissions, and/or the like. Additionally, protocol stack 30 can adjust the number of acknowledgements that are filtered based on one or more attributes of the communications connection. For example, protocol stack 30 can reduce the number of acknowledgements filtered for a communications connection that has relatively stable, but long round trip delays.

While shown and described herein as a method and system for managing a communications connection, it is understood that the invention further provides various alternative embodiments. For example, in one embodiment, the invention provides a computer program stored on a computer-readable medium, which when executed, enables a computer system to manage a communications connection. To this extent, the computer-readable medium includes program code, such as protocol stack 30 (FIG. 1) and/or one or more modules 40, 42, 44 for network adapter 24, which implement the process described herein. It is understood that the term “computer-readable medium” comprises one or more of any type of tangible medium of expression (e.g., physical embodiment) of the program code. In particular, the computer-readable medium can comprise program code embodied on one or more portable storage articles of manufacture, on one or more data storage portions of a computing device, such as memory 22A (FIG. 1) and/or storage system 22B (FIG. 1), as a data signal traveling over a network (e.g., during a wired/wireless electronic distribution of the computer program), on paper (e.g., capable of being scanned and converted to electronic data), and/or the like.

In another embodiment, the invention provides a method of generating a system for managing a communications connection. In this case, a computer system, such as computer system 12 (FIG. 1), can be obtained (e.g., created, maintained, having made available to, etc.) and one or more programs/systems for performing the process described herein can be obtained (e.g., created, purchased, used, modified, etc.) and deployed to the computer system. To this extent, the deployment can comprise one or more of: (1) installing program code on a computing device, such as computing device 14 (FIG. 1), from a computer-readable medium; (2) adding one or more computing devices to the computer system; and (3) incorporating and/or modifying one or more existing devices of the computer system, to enable the computer system to perform the process described herein.

In still another embodiment, the invention provides a business method that performs the process described herein on a subscription, advertising, and/or fee basis. That is, a service provider, such as an integrated solutions provider, could offer to manage a communications connection as described herein. In this case, the service provider can manage (e.g., create, maintain, support, etc.) a computer system, such as computer system 12 (FIG. 1), that performs the process described herein for one or more customers. In return, the service provider can receive payment from the customer(s) under a subscription and/or fee agreement, receive payment from the sale of advertising to one or more third parties, and/or the like.

As used herein, it is understood that “program code” means any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as some or all of one or more types of computer programs, such as an application/software program, component software/a library of functions, an operating system, a basic I/O system/driver for a particular computing, storage and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of managing a communications connection, the method comprising:
obtaining data for forwarding to a remote device;
communicating at least some of the data for processing on the remote device;
receiving an acknowledgement for the at least some of the data; and
determining whether to forward the acknowledgement based on an optimization configuration.

2. The method of claim 1, the optimization configuration including:
a filtering setting for designating whether any acknowledgements should be discarded; and
a segmentation offload setting for designating whether a protocol stack provides large data packets.

3. The method of claim 2, further comprising forwarding the acknowledgment when at least one of: the filtering setting is inactive or the segmentation offload setting is inactive.

4. The method of claim 1, the determining being further based on the acknowledgement, the method further comprising forwarding an acknowledgement that includes data that requires processing by a protocol stack.

5. The method of claim 1, the determining being further based on the acknowledgement and a previous acknowledgement, the method further comprising forwarding at least one copy of the acknowledgement when the acknowledgement includes an identical sequence number as a sequence number of the previous acknowledgement.

6. The method of claim 1, the determining being further based on a previously forwarded acknowledgement, the method further comprising forwarding an acknowledgement that is a threshold number of acknowledgements after the previously forwarded acknowledgement.

7. The method of claim 1, the determining being further based on a total number of packets for communicating the data, the method further comprising forwarding an acknowledgement that is received in response to a packet that is within a threshold number of the total number of packets.

8. A system for managing a communications connection, the system comprising:
a system for obtaining data for forwarding to a remote device;
a system for communicating at least some of the data for processing on the remote device;
a system for receiving an acknowledgement for the at least some of the data; and
a system for determining whether to forward the acknowledgement based on an optimization configuration.

9. The system of claim 8, the optimization configuration including:
a filtering setting for designating whether any acknowledgements should be discarded; and
a segmentation offload setting for designating whether the protocol stack provides large data packets.

10. The system of claim 8, further comprising a system for forwarding the acknowledgment.

11. The system of claim 8, further comprising a protocol stack, wherein the protocol stack provides the data for forwarding to the remote device.

12. The system of claim 11, wherein the protocol stack dynamically manages the optimization configuration based on at least one attribute of the communications connection.

13. The system of claim 11, the protocol stack comprising a transmission control protocol (TCP) stack.

14. A computer program stored on a computer-readable medium, which when executed, enables a computer system to manage a communications connection, the computer program comprising program code for enabling the computer system to:
obtain data for forwarding to a remote device;
communicate at least some of the data for processing on the remote device;
receive an acknowledgement for the at least some of the data; and
determine whether to forward the acknowledgement based on an optimization configuration.

15. The computer program of claim 14, further comprising program code for enabling the computer system to forward the acknowledgment.

16. The computer program of claim 15, further comprising program code for enabling the computer system to provide the data for forwarding to the remote device and receive a forwarded acknowledgement.

17. The computer program of claim 14, further comprising program code for enabling the computer system to dynamically manage the optimization configuration based on at least one attribute of the communications connection.

18. A network adapter comprising:
means for obtaining data for forwarding to a remote device;
means for communicating at least some of the data for processing on the remote device;
means for receiving an acknowledgement for the at least some of the data; and
means for determining whether to forward the acknowledgement based on an optimization configuration.

19. The network adapter of claim 18, further comprising means for forwarding the acknowledgment.

20. The network adapter of claim 18, further comprising means of obtaining the optimization configuration.
